(19) United States
(12) Patent Application Publication
(10) Pub. No.: US 2018/0089361 A1
(43) Pub. Date: Mar. 29, 2018

(54) Method for Scaling Turbomachine Airfoils

(71) Applicant: General Electric Company, Schenectady, NY (US)

(72) Inventors: Tao Guo, Niskayuna, NY (US); Michael Ernest Boisclair, Glenville, NY (US); Joseph Anthony Cotroneo, Clifton Park, NY (US); Douglas Carl Hofer, Clifton Park, NY (US); Amir Mujezinovic, Saratoga Springs, NY (US); Vsevolod Yuriyevich Ostrovskiy, Clifton Park, NY (US)

(21) Appl. No.: 15/280,118

(22) Filed: Sep. 29, 2016

(51) Int. Cl. G06F 17/50; F01D 5/14; F01D 9/02; F04D 29/32; F04D 29/54

(52) U.S. Cl. CPC G06F 17/5086; F01D 5/141; F01D 9/02; F04D 29/324; F05D 2240/307; F05D 2220/32; F05D 2220/31; F05D 2230/50; F05D 2240/125; F04D 29/542

(57) ABSTRACT

The present disclosure is directed to a method for scaling an airfoil for placement in a turbomachine. The method disclosed herein includes radially scaling a master airfoil to form a scaled airfoil. The method may also include tuning the scaled airfoil. For example, tuning the scaled airfoil may include axially scaling. The scaled airfoil generally has similar characteristics to the master airfoil.

### FIELD OF THE TECHNOLOGY

The present disclosure generally relates to turbomachines. More particularly, the present disclosure relates to methods for scaling airfoils for turbomachines.

### BACKGROUND

A steam turbine system generally includes a boiler, a high pressure turbine section, an intermediate turbine section, a low pressure turbine section, and a condenser. A shaft couples the high, intermediate, and low pressure turbine sections. In operation, the boiler heats liquid water into steam. The steam flows through the high, intermediate, and low pressure turbine sections, thereby rotating the one or more shafts. The shaft may be connected, e.g., to a generator to produce electricity. The steam then flows to the condenser, which cools the steam to liquid water. The liquid water is pumped back to the boiler for heating.

Each of the high, intermediate, and low pressure turbine sections may include one or more stages. In particular, each stage includes a row of circumferentially spaced apart stator vanes axially spaced apart from a row of circumferentially spaced apart rotor blades. The stator vanes direct steam flowing through the turbine sections onto the rotor blades, which extract kinetic and/or thermal energy from the steam. In this respect, the force of the steam flowing past the rotor blades causes the shaft to rotate.

Certain parameters of the high, intermediate, and/or low pressure turbine sections are typically determined early in the design process. For example, such parameters may include the number of rows of rotor blades and/or the radial heights and radii of each rotor blade. Nevertheless, the process of designing the rotor blades may be expensive and time consuming, particularly for the rotor blades in the low pressure turbine section. Specifically, extensive testing may be necessary to ensure that the rotor blades exhibit the desired aerodynamic performance and mechanical integrity under expected operating conditions.

Certain scaling methods may allow manufacturers to reuse existing stator vane and/or rotor blade designs without the need for developing a new stator vane and/or rotor blade design. In particular, such scaling methods seek to maintain the aerodynamic performance and mechanical integrity of the existing rotor blade design when the size of the rotor blade increases or decreases. One such method is known in industry as the “speed scaling” method. Using this method, a stator vane or rotor blade designed for use in a turbine operating at a specific rotational speed (e.g., 3600 rpm) may be scaled for use in a turbine operating at a different rotational speed (e.g., 3000 rpm, 1800 rpm, etc.), while maintaining similar aerodynamic performance and mechanical integrity. Specifically, both the radial and the axial dimensions of the scaled stator vanes and/or rotor blades change by a factor of rpm1/rpm2, where rpm1 is the original design speed and rpm2 is the new design speed. In this respect, speed scaling and other known scaling methods do not permit the radial and the axial dimensions of the stator vanes and/or rotor blades to be changed independently. Furthermore, these scaling methods do not permit the scaling of the stator vanes and/or rotor blades based on changes in flow rate when the rotational speed remains constant.

### BRIEF DESCRIPTION OF THE TECHNOLOGY

Aspects and advantages of the technology will be set forth in part in the following description, or may be obvious from the description, or may be learned through practice of the technology.

In one aspect, the present disclosure is directed to a method for scaling an airfoil for placement in a turbomachine. The method includes designing a master airfoil having a plurality of master airfoil sections. Each master airfoil section includes a master airfoil section radius and a master airfoil section axial width. One of the plurality of master airfoil sections is selected as a master airfoil reference section. The master airfoil reference section includes a master airfoil reference section radius and a master airfoil reference section axial width. For each of the plurality of master airfoil sections, a ratio of the corresponding master airfoil section radius to the master airfoil reference section radius is calculated. A scaled airfoil reference section radius is determined for a scaled airfoil reference section of a scaled airfoil. The scaled airfoil reference section corresponds to the master airfoil reference section. The scaled airfoil includes a plurality of scaled airfoil sections. Each of the plurality of scaled airfoil sections corresponds to one of the plurality of master airfoil sections. A scaled airfoil section radius is calculated for each of the plurality of scaled airfoil sections. A ratio of the scaled airfoil section radius to the scaled airfoil reference section radius for each of the plurality of scaled airfoil sections is the same as the ratio of the master airfoil section radius to the master airfoil reference section radius for the corresponding master airfoil section.

In a further aspect, the present disclosure is directed to a method for scaling an airfoil for placement in a stage of a turbomachine. The method includes designing a master airfoil having a plurality of master airfoil sections. Each master airfoil section includes a master airfoil section radius and a master airfoil section axial width. One of the plurality of master airfoil sections is selected as a master airfoil reference section. The master airfoil reference section includes a master airfoil reference section radius and a master airfoil reference section axial width. For each of the plurality of master airfoil sections, a ratio of the corresponding master airfoil section radius to the master airfoil reference section radius is calculated. A scaled airfoil reference section radius is determined for a scaled airfoil reference section of a scaled airfoil. The scaled airfoil reference section corresponds to the master airfoil reference section. The scaled airfoil includes a plurality of scaled airfoil sections. Each of the plurality of scaled airfoil sections corresponds to one of the plurality of master airfoil sections. A scaled airfoil section radius is calculated for each of the plurality of scaled airfoil sections. A ratio of the scaled airfoil section radius to the scaled airfoil reference section radius for each of the plurality of scaled airfoil sections is the same as the ratio of the master airfoil section radius to the master airfoil reference section radius for the corresponding master airfoil section. The scaled airfoil is cut at a cut radius.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended FIGS., in which:

FIG. 1 is a schematic view of an exemplary steam turbine system, which may incorporate various embodiments disclosed herein;

FIG. 2 is a side view of a portion of a low pressure turbine section of the steam turbine system shown in FIG. 1, which may incorporate various embodiments disclosed herein;

FIG. 3 is a perspective view of an exemplary row of rotor blades of the low pressure turbine section shown in FIG. 2, which may incorporate various embodiments disclosed herein;

FIG. 4 is a perspective view of an exemplary rotor blade of the row of rotor blades shown in FIG. 3, which may incorporate various embodiments disclosed herein;

FIG. 5 is a flow chart illustrating a method for scaling an airfoil in accordance with the embodiments disclosed herein;

FIG. 6 is a side view of a master airfoil and a scaled airfoil created from the master airfoil, illustrating the various features thereof;

FIG. 7 is a side view of the master airfoil and an alternate embodiment of the scaled airfoil created from the master airfoil, illustrating the various features thereof;

FIG. 8 is a flow chart illustrating a method for tuning the airfoil in accordance with the embodiments disclosed herein;

FIG. 9 is a side view of the master airfoil and the scaled airfoil shown in FIG. 6, illustrating the various axial lengths thereof;

FIG. 10 is a top view of the master airfoil, further illustrating the various features thereof; and

FIG. 11 is a top view of the scaled airfoil, further illustrating the various features thereof.

Repeat use of reference characters in the present specification and drawings is intended to represent the same or analogous features or elements of the present technology.

### DETAILED DESCRIPTION OF THE TECHNOLOGY

Reference will now be made in detail to present embodiments of the technology, one or more examples of which are illustrated in the accompanying drawings. The detailed description uses numerical and letter designations to refer to features in the drawings. Like or similar designations in the drawings and description have been used to refer to like or similar parts of the technology. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

Each example is provided by way of explanation of the technology, not limitation of the technology. In fact, it will be apparent to those skilled in the art that modifications and variations can be made in the present technology without departing from the scope or spirit thereof. For instance, features illustrated or described as part of one embodiment may be used on another embodiment to yield a still further embodiment. Thus, it is intended that the present technology covers such modifications and variations as come within the scope of the appended claims and their equivalents.

Although a steam turbine is shown and described herein, the present technology as shown and described herein is not limited to steam turbine unless otherwise specified in the claims. For example, the technology as described herein may be used in any type of turbine including, but not limited to, industrial or land-based gas turbines, aviation gas turbines (e.g., turbofans, etc.), marine gas turbines, and compressors.

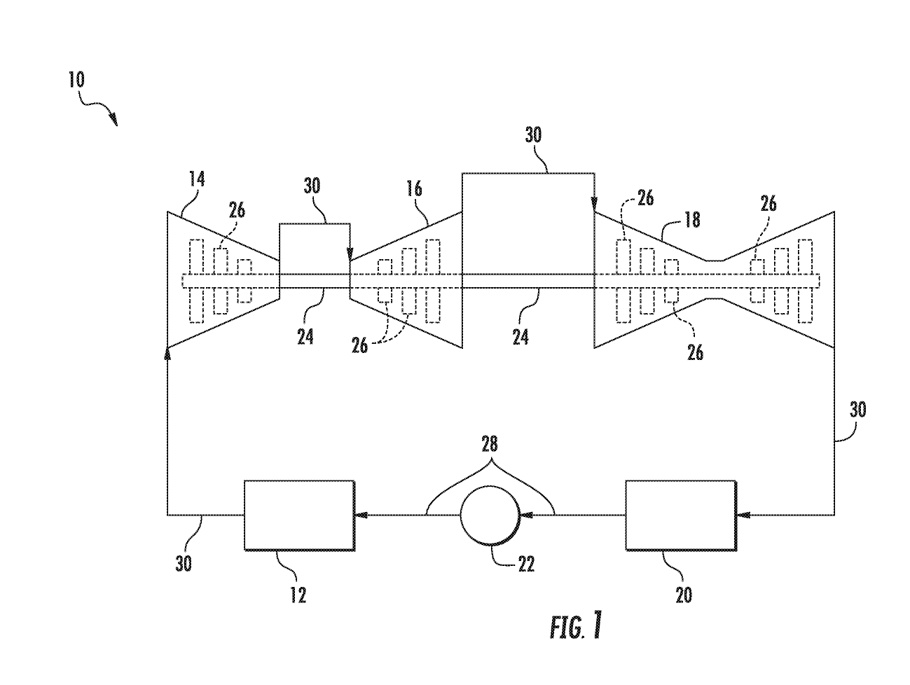

Referring now to the drawings, wherein identical numerals indicate the same elements throughout the figures, FIG. 1 schematically illustrates an exemplary steam turbine system 10. It should be understood that the turbine system 10 of the present disclosure need not be a steam turbine system, but rather may be any suitable turbine system, such as a gas turbine system or other suitable engine. The steam turbine system 10 may include a boiler 12, a high pressure turbine section 14, an intermediate pressure turbine section 16, a low pressure turbine section 18, a condenser 20, and a pump 22. The high, intermediate, and low pressure turbine sections 14, 16, 18 may be coupled by a shaft 24. The shaft 24 may be a single shaft or a plurality of shaft segments coupled together to form the shaft 24.

Each of the high, intermediate, and low pressure turbine sections 14, 16, 18 may include one or more stages 26, which will be discussed in greater detail below. In the embodiment shown in FIG. 1, the high and intermediate pressure turbine sections 14, 16 each include three stages 26, and the low pressure turbine section 18 includes six stages 26. In other embodiments, however, the high, intermediate, and low pressure turbine sections 14, 16, 18 may include more or fewer stages 26.

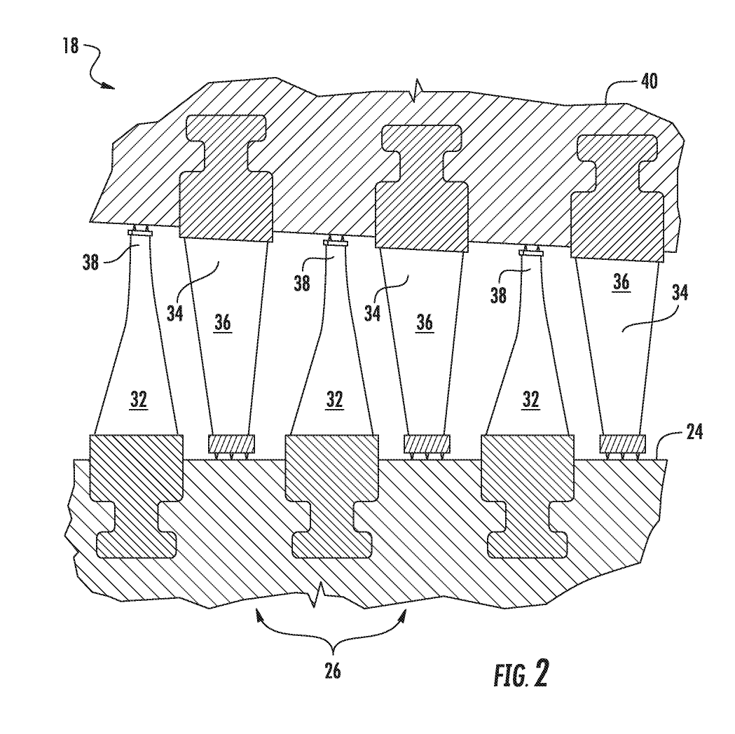

During operation, the steam turbine system 10 produces mechanical rotational energy, which may, e.g., be used to generate electricity. More specifically, the boiler 12 heats liquid water 28 to produce steam 30, which flows through the high, intermediate, and low pressure turbine sections 14, 16, 18. One or more rotor blades 32 (FIG. 2) in each of the stages 26 of the turbine sections 14, 16, 18 extract a portion of the kinetic and/or thermal energy from the steam 30. This energy extraction rotates the shaft 24, which may be used to power a generator (not shown) to generate electricity. The steam 30 then flows to the condenser 20, which converts the steam 30 into liquid water 28. The pump 22 pumps the liquid water 28 to boiler 12.

FIG. 2 is a side view of a portion of the low pressure turbine section 18. As mentioned above, the low pressure turbine section 18 includes one or more stages 26. As shown in FIG. 2, each stage 26 includes a row 34 of circumferentially spaced apart stator vanes 36 and a row 38 of circumferentially spaced apart rotor blades 32. In each stage 26, the row 34 of stator vanes 36 is positioned upstream from and axially spaced apart from the row 38 of rotor blades 32. The stator vanes 36 couple to a casing 40 that circumferentially surrounds each of the stages 26 in the low pressure turbine section 18. Conversely, the rotor blades 32 couple to the shaft 24. During operation of the steam turbine system 10, the stator vanes 36 remain stationary relative to the rotor blades 32. The stages 26 in the high and/or intermediate pressure turbine sections 14, 16 may have similar configurations.

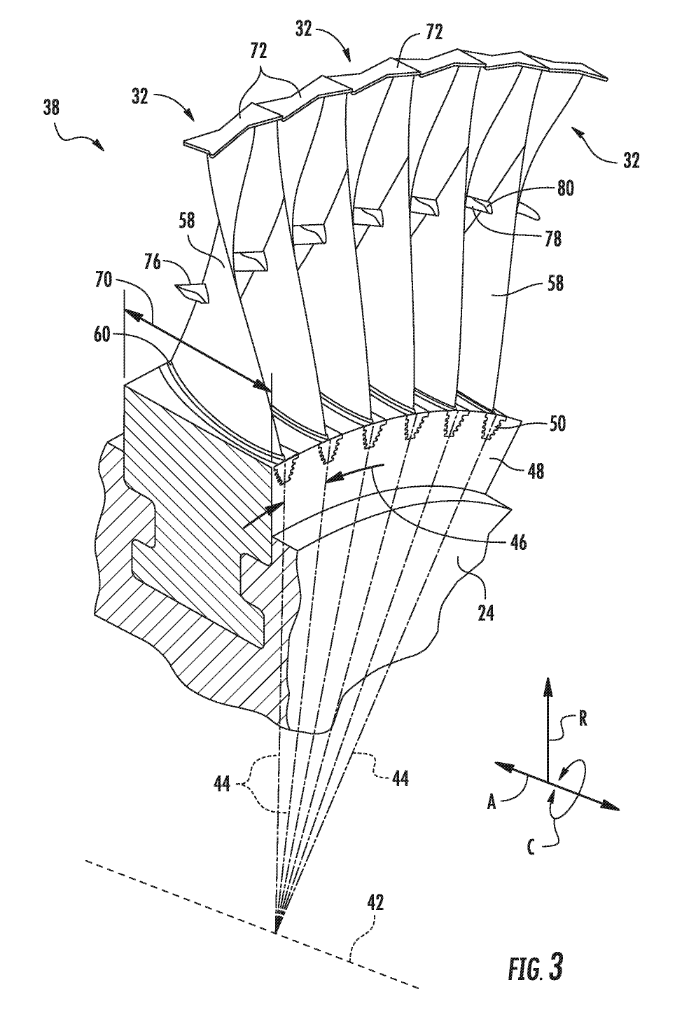

FIG. 3 illustrates one of the rows 38 of rotor blades 32 in the low pressure turbine section 18. As shown, the shaft 24 defines an axial centerline 42 and extends at least partially through the low pressure turbine section 18. In this respect, the low pressure turbine section 18 defines an axial direction A, a radial direction R, and a circumferential direction C. In general, the axial direction A extends parallel to the axial centerline 42, the radial direction R extends orthogonally outward from the axial centerline 42, and the circumferential direction C extends concentrically around the axial centerline 42.

As mentioned above and illustrated in FIG. 3, the rotor blades 32 in the row 38 thereof are circumferentially spaced apart. In this respect, each rotor blade 32 defines a radial centerline 44 that extends radially inward to the axial centerline 42 of the shaft 24. As such, the radial centerlines 44 of each adjacent pair of rotor blades 32 are circumferentially spaced apart by a circumferential spacing 46. In the embodiment shown in FIG. 3, a rotor disk 48 may couple the row 38 of rotor blades 32 to the shaft 24. Although, the row 38 of rotor blades 32 may couple to the shaft 24 in any suitable manner in alternate embodiments.

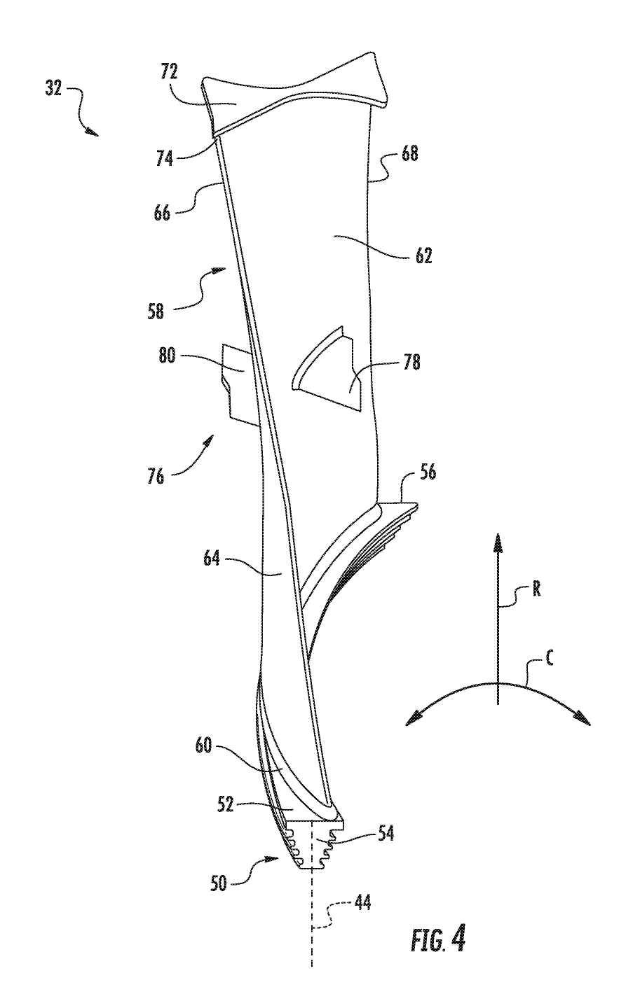

FIG. 4 illustrates one of the rotor blades 32 in greater detail. As depicted, the rotor blade 32 may include a dovetail 50 that secures the rotor blade 32 to the rotor disk 48 (FIG. 3). A platform 52 may couple to and extend radially outward from the dovetail 50. In the embodiment shown in FIG. 4, the dovetail 50 is a curved axial entry fir tree-type dovetail. In this respect, the dovetail 50 and the platform 52 include a leading edge surface 54 axially and circumferentially spaced apart from a trailing edge surface 56. As such, dovetail 50 and the platform 52 are curved in the axial direction A. In alternate embodiments, the leading edge surface 54 may be axially aligned with the trailing edge surface 56. In fact, the dovetail 50 and/or the platform 52 may have any suitable configuration.

FIG. 3 shows the radial centerline 44 extending radially through the circumferential center of the leading edge surface 54. Although, the radial centerline 44 may be aligned with any part of the dovetail 50 and/or the rotor blade 32.

The rotor blade 32 also includes an airfoil 58 that extends radially outward from the platform 52. In this respect, a root section 60 of the airfoil 58 couples to the platform 52. As shown in FIG. 4, the airfoil 58 includes a pressure-side wall 62 and an opposing suction-side wall 64. The pressure-side and suction-side walls 62, 64 are joined together at a leading edge 66, which is oriented into the flow of steam 30. Similarly, the pressure-side and suction-side walls 62, 64 are also joined together at a trailing edge 68 positioned downstream from the leading edge 66. The pressure-side and suction-side walls 62, 64 may be continuous about the leading and trailing edges 66, 68. The pressure-side wall 62 is generally concave, while the suction-side wall 64 is generally convex.

Referring again to FIG. 3, the airfoil 58 includes an axial length 70. In particular, the axial length 70 is the distance between the leading edge 66 and the trailing edge 68 in the axial direction A. The axial length 70 of the airfoil 58 may vary along the radial direction R. That is, the axial length 70 may decrease as the airfoil 58 extends radially outward. The axial length 70 of the airfoil 58 shown in FIG. 3 is measured at the root section 60 thereof.

The rotor blade 32 may include a tip shroud 72. Specifically, the tip shroud 72 couples to an airfoil tip 74 (i.e., the radially outermost portion of the airfoil 58) to define the radially outermost portion of the rotor blade 32. As shown in FIG. 2, the tip shroud 72 of each rotor blade 32 engages the tip shrouds 72 of the adjacent rotor blades 32. As will be discussed in greater detail below, the size, mass, and/or position of the tip shroud 72 may affect the frequency response of the rotor blade 32. Some embodiments of the rotor blade 32 may not include the tip shroud 72.

Furthermore, the rotor blade 32 may also have a part-span shroud 76. In particular, the part-span shroud 76 couples to the airfoil 58 at a position radially between the root section 60 and the airfoil tip 74. The part-span shroud 76 includes a pressure-side portion 78 coupled to the pressure side wall 62 of the airfoil 58 and the suction-side portion 80 coupled to the suction-side wall 64 of the airfoil 58. As shown in FIG. 3, the pressure-side portion 78 of the part-span shroud 76 of one airfoil 58 engages the suction-side portion 80 of the part-span shroud 76 of the adjacent airfoil 58. As will be discussed in greater detail below, the size, mass, and/or position of the part span shroud 76 may affect the frequency response of the rotor blade 32. In the embodiment shown in FIGS. 2 and 3, the part span shroud 76 has a winglet configuration. Nevertheless, the part span shroud 76 may have a nub and sleeve configuration or any other suitable configuration. Some embodiments of the rotor blade 32 may not include the part span shroud 76.

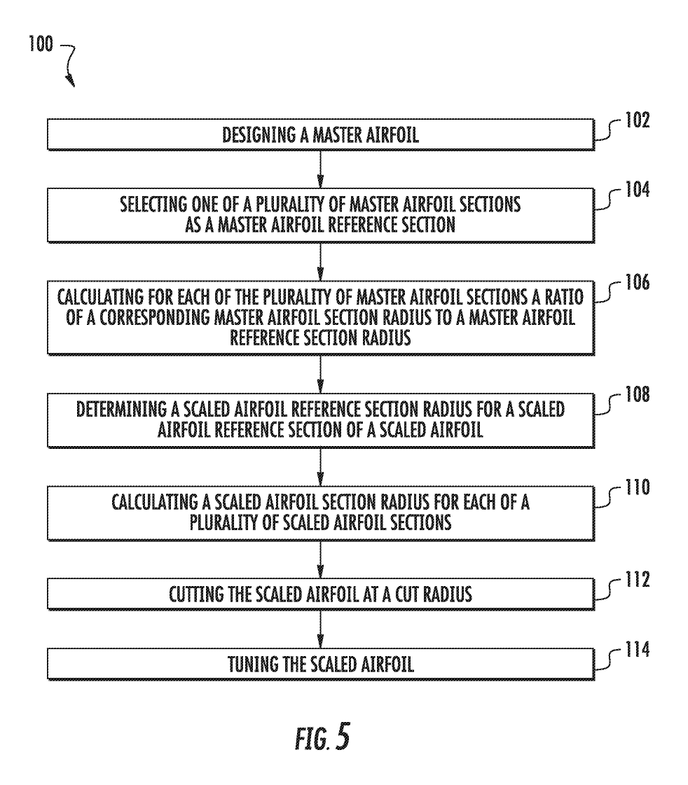

FIG. 5 illustrates one embodiment of a method 100 for scaling a master airfoil 200 to create a scaled airfoil 202. As will be discussed in greater detail below, steps 102-112 of the method 100 are directed to scaling the master airfoil 200 in the radial direction R to form the scaled airfoil 202. Step 114 of the method 100 is directed to tuning the frequency response of the scaled airfoil 202. The scaled airfoil 202 may be incorporated into one or more of the stator vanes 36 and/or one or more of the rotor blades 32 positioned in the high, intermediate, and/or low pressure turbine sections 14, 16, 18 of the steam turbine system 10. In particular, the scaled airfoil 202 may be used in place of the airfoil 200.

In step 102, the master airfoil 200 is designed. More specifically, the master airfoil 200 includes a profile and/or shape having desired operational characteristics under the expected operating conditions. In this respect, the master airfoil 200 may undergo extensive testing (e.g., flow testing, frequency testing, wheel box testing, etc.) to ensure it exhibits the desired operational characteristics (e.g., flow rates, work coefficient, reaction, velocity triangles, frequencies, etc.) and is suitable for the desired application. The master airfoil 200 may be an electronic model of an airfoil (e.g., a CAD model) or a physical airfoil (e.g., a cast or machined component).

The master airfoil 200 includes a plurality of master airfoil sections. Specifically, each master airfoil section is radially spaced apart from the axial centerline 42 of the shaft 24 as well as each of the other master airfoil sections. In the embodiment shown in FIG. 5, the master airfoil 200 includes five master airfoil sections. In alternate embodiments, however, the master airfoil 200 may include more or fewer master airfoil sections.

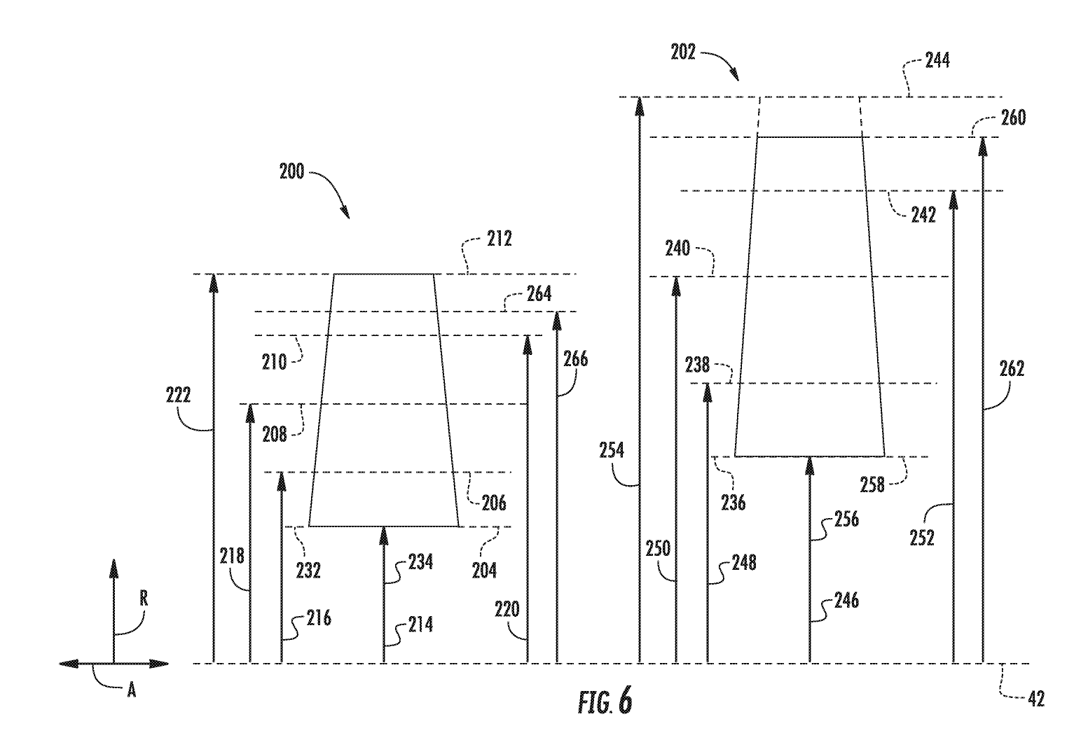

In the embodiment shown in FIG. 6, the master airfoil 200 includes a first master airfoil section 204, a second master airfoil section 206, a third master airfoil section 208, a fourth master airfoil section 210, and a fifth master airfoil section 212. More specifically, the first master airfoil section 204 is spaced apart from the axial centerline 42 by a first master airfoil section radius 214. The second master airfoil section 206 is spaced apart from the axial centerline 42 by a second master airfoil section radius 216. The third master airfoil section 208 is spaced apart from the axial centerline 42 by a third master airfoil section radius 218. The fourth master airfoil section 210 is spaced apart from the axial centerline 42 by a fourth master airfoil section radius 220. The fifth master airfoil section 212 is spaced apart from the axial centerline 42 by a fifth master airfoil section radius 222.

As illustrated in FIG. 6, the first, second, third, fourth, fifth master airfoil sections 204, 206, 208, 210, 212 are spaced apart in the radial direction R. In particular, the first master airfoil section 204 is positioned at the radially innermost portion of the master airfoil 200 (i.e., the root section), and the fifth master airfoil section 212 is positioned at the radially outermost portion of the master airfoil 200 (i.e., the tip). The second, third, and fourth master airfoil sections 206, 208, 210 are positioned radially between the first and fifth master airfoil sections 204, 212. In alternate embodiments, the master airfoil sections may be positioned at any suitable radial position on the master airfoil 200.

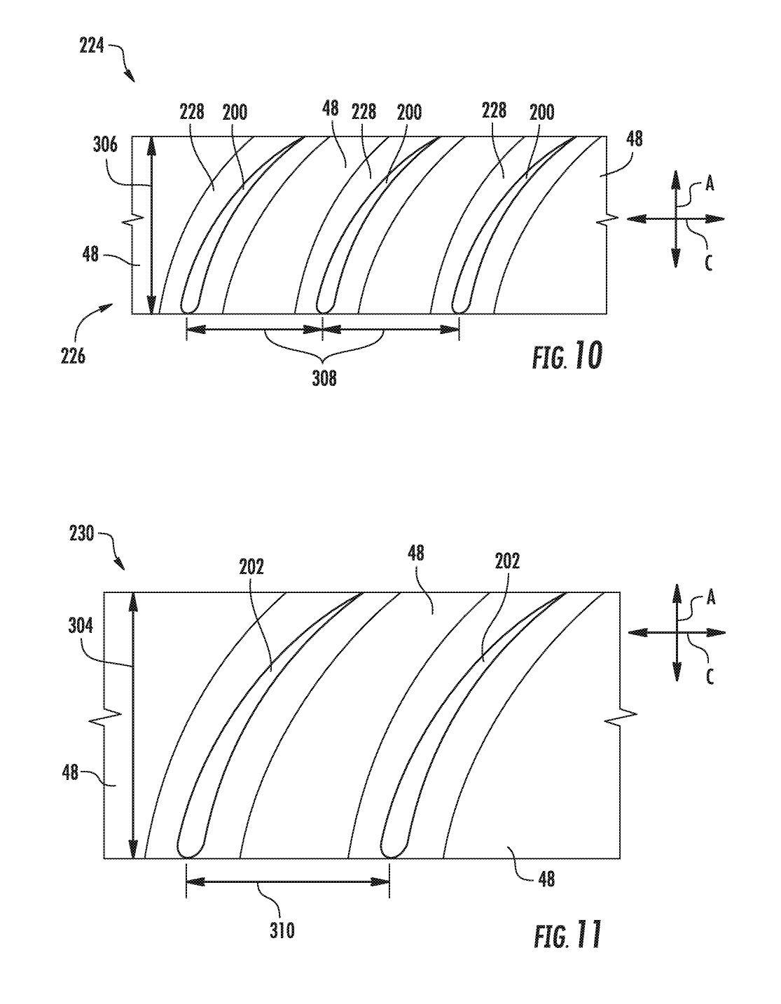

In some embodiments, the master airfoil 200 may be used to form a master stage. Specifically, the master airfoil 200 may be used to form a row (not shown) of master stator vanes (not shown) and a row 224 (FIG. 10) of master rotor blades 228 (FIG. 10). As will be discussed in greater detail below, the row 224 of the master stage may be scaled to form a row 230 (FIG. 11) of a scaled stage, which may be incorporated into one or more of the high, intermediate, and low pressure turbine sections 14, 16, 18 of the steam turbine system 10 in place of one or more of the stages 26. In some embodiments, the scaled airfoils 202 incorporated in the stator vanes 36 may have a different scale factor than the scaled airfoils 202 incorporated into the rotor blades 32.

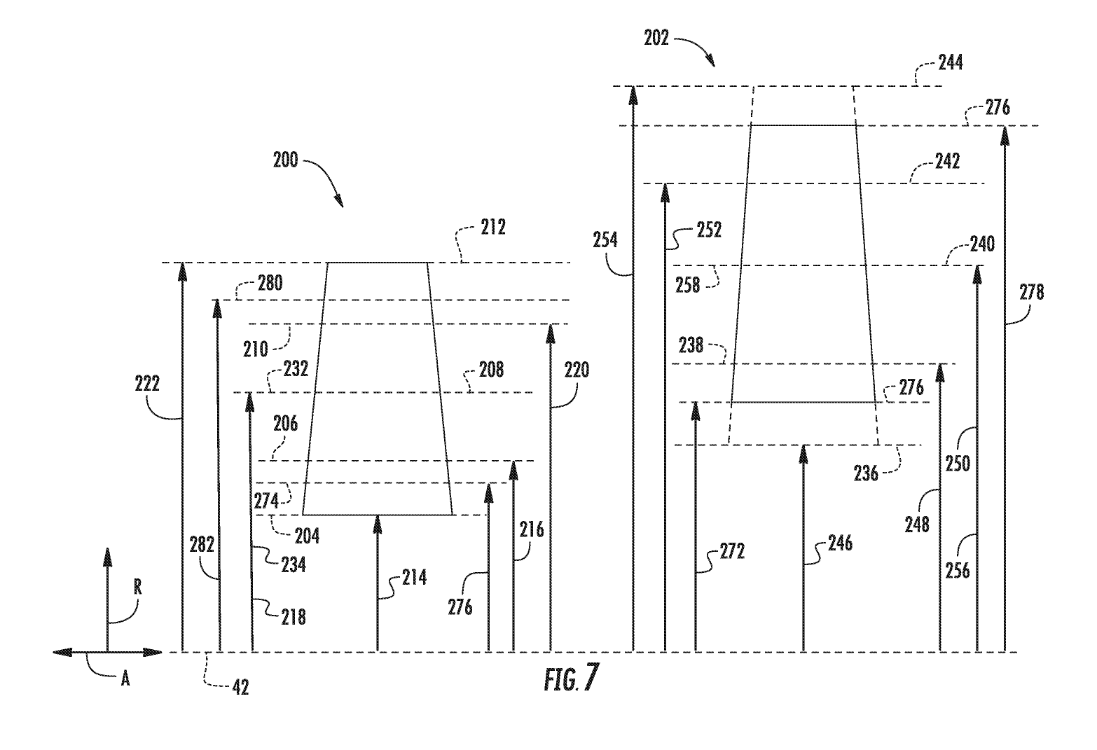

Referring again to FIG. 5, one of the master airfoil sections is selected as a master airfoil reference section 232 in step 104. The master airfoil reference section 232 includes a master airfoil reference section radius 234. In the embodiment shown in FIG. 6, the first master airfoil section 204 is selected as the master airfoil reference section 232. As such, the first master airfoil section radius 214 is a master airfoil reference section radius 234. In the embodiment shown in FIG. 7, the third master airfoil section 208 is selected as the master airfoil reference section 232. As such, the third master airfoil section radius 218 is the master airfoil reference section radius 234. In alternate embodiments, however, any of the master airfoil sections may be selected as the master airfoil reference section 232. In such embodiments, the master airfoil reference section radius 234 would be the radius of the particular master airfoil section selected as the master airfoil reference section 232.

In step 106, a ratio of the master airfoil section radius to the master airfoil reference section radius 234 for each master airfoil section is calculated. In particular, the first, second, third, fourth, and fifth master airfoil section radii 214, 216, 218, 220, 222 are each divided by the master airfoil reference section radius 234 to respectively obtain a first master airfoil section radius ratio, a second master airfoil section radius ratio, a third master airfoil section radius ratio, a fourth master airfoil section radius ratio, and a fifth master airfoil section radius. Preferably, each of the master airfoils 200 has a fifth master airfoil section radius capable of satisfying the requirements for the high pressure, intermediate pressure, and/or low pressure turbine section 14, 16, 18 application for which it is intended.

As mentioned above, the first master airfoil section 204 is the master airfoil reference section 232 in the embodiment shown in FIG. 6. In this respect, the first master airfoil section radius ratio is one in this embodiment. Since the second, third, fourth, and fifth master airfoil sections 206, 208, 210, 212 are positioned radially outward from the first master airfoil section 204, the second, third, fourth, and fifth master airfoil section radius ratios are greater than one.

In the embodiment shown in FIG. 7, the third master airfoil section 208 is the master airfoil reference section 232. As such, the third master airfoil section radius ratio is one in this embodiment. Since the first and second master airfoil sections 204, 206 are positioned radially inward from the third master airfoil section 208, the first and second master airfoil section radius ratios are less than one. Conversely, the fourth and fifth master airfoil section radius ratios are greater than one because the fourth and fifth master airfoil sections 210, 212 are positioned radially outward from the third master airfoil section 208.

The radials dimensions of the scaled airfoil 202 may be determined in steps 108-112. For clarity, various features and aspects of the scaled airfoil 202 will be described below before discussing steps 108-112.

The scaled airfoil 202 includes a plurality of scaled airfoil sections that each correspond to one of the plurality of master airfoil sections. In this respect, the scaled airfoil 202 generally has the same number of scaled airfoil sections as the master airfoil 200 has master airfoil sections. Like the master airfoil sections, each scaled airfoil section is radially spaced apart from the other scaled airfoil sections. Furthermore, the scaled airfoil sections are generally positioned on the scaled airfoil 202 in a similar manner as the master airfoil sections are positioned on the master airfoil 200. For example, if one of the master airfoil sections is positioned at a root section of the master airfoil 200, then the corresponding scaled airfoil section would be positioned at a root section of the scaled airfoil 202.

In the embodiment shown in FIGS. 6 and 7, the scaled airfoil 202 includes a first scaled airfoil section 236, a second scaled airfoil section 238, a third scaled airfoil section 240, a fourth scaled airfoil section 242, and a fifth scaled airfoil section 244. More specifically, the first scaled airfoil section 236 corresponds to the first master airfoil section 204. The second scaled airfoil section 238 corresponds to the second master airfoil section 206. The third scaled airfoil section 240 corresponds to the third master airfoil section 208. The fourth scaled airfoil section 242 corresponds to the fourth master airfoil section 210. The fifth scaled airfoil section 244 corresponds to the fifth master airfoil section 212.

As shown, the first, second, third, fourth, and fifth scaled airfoil sections 236, 238, 240, 242, 244 are respectively spaced apart from the axial centerline 42 by a first scaled airfoil radius 246, a second scaled airfoil radius 248, a third scaled airfoil radius 250, a fourth scaled airfoil radius 252, and a fifth scaled airfoil radius 254. In this respect, the first scaled airfoil section radius 246 corresponds to the first master airfoil section radius 214. The second scaled airfoil section radius 248 corresponds to the second master airfoil section radius 216. The third scaled airfoil section radius 250 corresponds to the third master airfoil section radius 218. The fourth scaled airfoil section radius 252 corresponds to the fourth master airfoil section radius 220. The fifth scaled airfoil section radius 254 corresponds to the fifth master airfoil section radius 222.

Referring again to FIG. 5, a scaled airfoil reference section radius 256 of a scaled airfoil reference section 258 of the scaled airfoil 202 is determined in step 108. More specifically, the scaled airfoil reference section 258 and the scaled airfoil reference section radius 256 respectively correspond to the master airfoil reference section 232 and the master airfoil reference section radius 234. In the embodiment shown in FIG. 6, the master airfoil reference section 232 is the first master airfoil section 204. As such, the first scaled airfoil section 236 is the scaled airfoil reference section 258, and the first scaled airfoil section radius 246 is the scaled airfoil reference section radius 256. In the embodiment shown in FIG. 7, however, the master airfoil reference section 232 is the third master airfoil section 208. Accordingly, the third scaled airfoil section 240 is the scaled airfoil reference section 258, and the third scaled airfoil section radius 250 is the scaled airfoil reference section radius 256. The scaled airfoil reference section radius 256 may be determined based on any suitable operating characteristic of the scaled airfoil 202 (e.g., desired number of stages, desired work coefficient, etc.).

The scaled airfoil reference section radius 256 is generally different than the master airfoil reference section radius 234. That is, the scaled airfoil reference section radius 256 is the dimension to which the master airfoil 200 is being radially scaled to create the scaled airfoil 202. As such, step 108 may be performed before steps 104 or 106 in some embodiments.

In step 110, the scaled airfoil section radius is calculated for each of the plurality of scaled airfoil sections. More specifically, each of the scaled airfoil sections includes a scaled airfoil section radius ratio, which is the ratio of the corresponding scaled airfoil section radius to the scaled airfoil reference section radius 256. Each of the scaled airfoil section radius ratios corresponds to one of the master airfoil section radius ratios. In this respect, each of the scaled airfoil section radius ratios is the same as the corresponding master airfoil section radius ratio. As such, the scaled airfoil section radius for each of the scaled airfoil sections may be calculated by multiplying the corresponding scaled airfoil section radius ratio and the scaled airfoil reference section radius. As such, the flow vector diagrams of the master and scaled airfoils 200, 202 remain the same.

As mentioned above, the scaled airfoil 202 includes the first, second, third, fourth, and fifth scaled airfoil sections 236, 238, 240, 242, 244 in the embodiments shown in FIGS. 6 and 7. Each of these scaled airfoil sections 236, 238, 240, 242, 244 respectively include a first scaled airfoil section radius ratio, a second scaled airfoil section radius ratio, a third scaled airfoil section radius ratio, a fourth scaled airfoil section radius ratio, and a fifth scaled airfoil section radius ratio. The first scaled airfoil section radius ratio corresponds to and is the same as the first master airfoil section radius ratio. The second scaled airfoil section radius ratio corresponds to and is the same as the second master airfoil section radius ratio. The third scaled airfoil section radius ratio corresponds to and is the same as the third master airfoil section radius ratio. The fourth scaled airfoil section radius ratio corresponds to and is the same as the fourth master airfoil section radius ratio. The fifth scaled airfoil section radius ratio corresponds to and is the same as the fifth master airfoil section radius ratio.

In optional step 112, the scaled airfoil 202 may be cut at one or more scaled airfoil cut sections. More specifically, some embodiments of the master airfoil 200 may include master airfoil sections having master airfoil section radius ratios that are greater than a maximum radius ratio or less than a minimum radius ratio of the scaled airfoil 200 after it is cut. The maximum and minimum radius ratios may be based on flow rate or other desired flow characteristics of the scaled airfoil 202. In this respect, the master airfoil 200 may include one or more master airfoil cut sections where the master airfoil section radius ratios are equal to the maximum or minimum radius ratios. In this respect, the scaled airfoil 202 includes the one or more scaled airfoil cut sections, which correspond to the master airfoil cut sections. That is, like the master airfoil cut sections, the scaled airfoil cut sections have scaled airfoil section radius ratios equal to the maximum or minimum radius ratios. In order to maintain desired flow characteristics, the portions of the scaled airfoil 202 having scaled airfoil section radius ratios greater than the maximum radius ratio or less than the minimum radius ration are removed from (i.e., cut off of) the scaled airfoil 202. The scaled airfoil cut radii designates the radial position on the scaled airfoil 202 where this cutting occurs. In general, step 112 occurs after step 110.

In the embodiment shown in FIG. 6, a radially outer portion of the scaled airfoil 202 is removed in step 112. As mentioned above, the master airfoil reference section 232 and the scaled airfoil reference section 258 in the embodiment shown in FIG. 6 are respectively positioned at the radially innermost portion (i.e., the root section) of the master airfoil 200 and the scaled airfoil 202. In this respect, the scaled airfoil 202 is cut at a scaled airfoil cut section 260 spaced apart from the axial centerline 42 by a scaled airfoil cut section radius 262. The scaled airfoil cut section 260 corresponds to the master airfoil cut section 264 spaced apart from the axial centerline 42 by a master airfoil cut section radius 266. The master and scaled airfoil cut sections 264, 260 each have the maximum radius ratio of the cut blade.

In the embodiment shown in FIG. 7, a radially inner portion and a radially outer portion of the scaled airfoil 202 are removed in step 112. As mentioned above, the master airfoil reference section 232 and the scaled airfoil reference section 258 in the embodiment shown in FIG. 6 are respectively positioned between the radially innermost portion (i.e., the root section) and the radially outermost portion (i.e., the tip) of the master airfoil 200 and the scaled airfoil 202. In this respect, the scaled airfoil 202 is cut at a scaled airfoil inner cut section 268 spaced apart from the axial centerline 42 by a scaled airfoil inner cut section radius 270. The scaled airfoil inner cut section 268 corresponds to the master airfoil inner cut section 272 spaced apart from the axial centerline 42 by a master airfoil inner cut section radius 274. The master and scaled airfoil inner cut sections 272, 268 each have the minimum radius ratio. Furthermore, the scaled airfoil 202 is cut at a scaled airfoil outer cut section 276 spaced apart from the axial centerline 42 by a scaled airfoil outer cut section radius 278. The scaled airfoil outer cut section 276 corresponds to the master airfoil outer cut section 280 spaced apart from the axial centerline 42 by a master airfoil outer cut section radius 282. The master and scaled airfoil outer cut sections 280, 276 each have the maximum radius ratio of the cut blade.

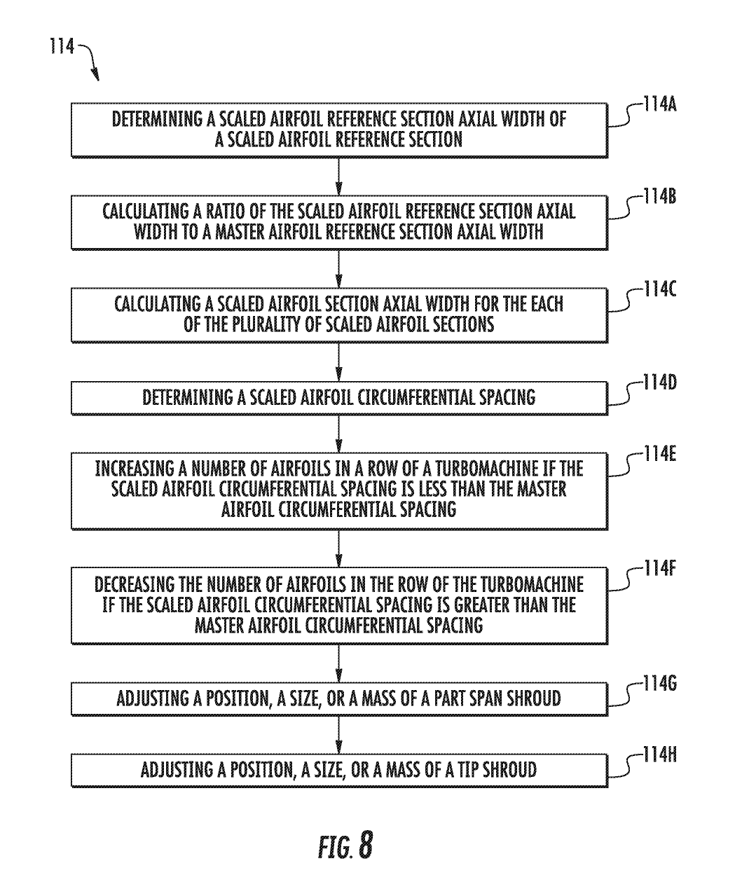

Referring again to FIG. 5, method 100 may include tuning the scaled airfoil 202 in optional step 114. In particular, step 114 may be used to tune the frequency response of the scaled airfoil 202. Furthermore, step 114 may be used to change the per revolution stimulus on adjacent rows of blades by changing blade count per row. Axial scaling may be used to obtain acceptable root bending stress. FIG. 8 illustrates one embodiment of step 114. Step 114 may include steps 114A-114F, which may be used to tune the scaled airfoil 202 by axially scaling the scaled airfoil 202. Step 114 may also include steps 114G and 114H, which may be respectively used to tune the scaled airfoil 202 with the tip shroud 72 and part span shroud 76. In general, step 114 occurs after step 110 and, if applicable, step 112.

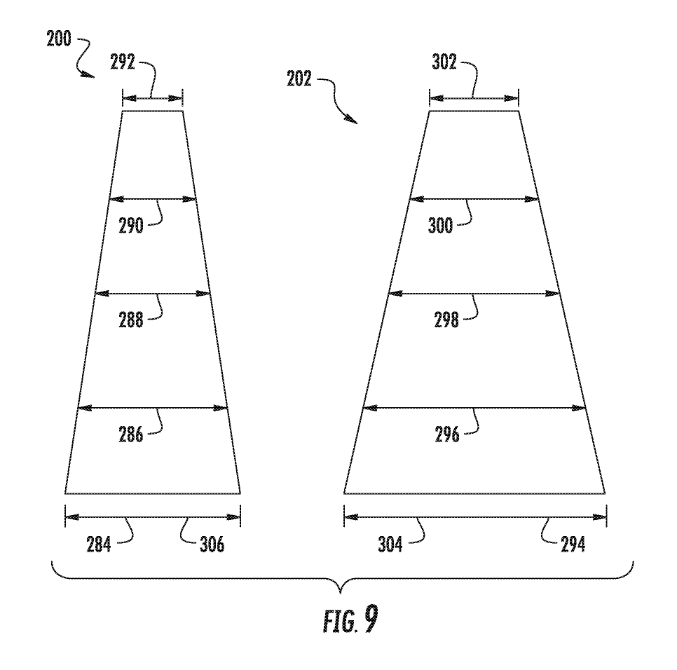

For clarity, various axial dimensions of the master and scaled airfoils 200, 202 are described before discussing steps 114A-114H. As mentioned above, the master airfoil 200 includes a plurality of master airfoil sections. In this respect, each master airfoil section includes a master airfoil section axial width. In the embodiment shown in FIG. 9, the master airfoil 200 includes a first master airfoil section axial width 284, a second master airfoil section axial width 286, a third master airfoil section axial width 288, a fourth master airfoil section axial width 290, and a fifth master airfoil section axial width 292. The first, second, third, fourth, and fifth master airfoil section axial widths 284, 286, 288, 290, 292 respectively correspond to the first, second, third, fourth, and fifth master airfoil sections 204, 206, 208, 210, 212 shown in FIG. 6. The scaled airfoil 202 includes a first scaled airfoil section axial width 294, a second scaled airfoil section axial width 296, a third scaled airfoil section axial width 298, a fourth scaled airfoil section axial width 300, and a fifth scaled airfoil section axial width 302. The first, second, third, fourth, and fifth scaled airfoil section axial widths 294, 296, 298, 300, 302 respectively correspond to the first, second, third, fourth, and fifth scaled airfoil sections 204, 206, 208, 210, 212 shown in FIG. 6.

Referring now to FIG. 8, a scaled airfoil reference section axial width 304 of the scaled airfoil reference section 258 is determined in step 114A. The scaled airfoil reference section axial width 304 may be chosen based on strength characteristics (e.g., ability to withstand expected bending stress), frequency characteristics, or any other suitable characteristic of the scaled airfoil 202. In the embodiment shown in FIG. 9, the first scaled airfoil section 236 is the scaled airfoil reference section 258, and the first scaled airfoil section axial width 294 is the scaled airfoil reference section axial width 304. Since it corresponds to the first scaled airfoil section 236 as discussed above, the first master airfoil section 204 is the master airfoil reference section 232. As such, the first master airfoil section axial width 284 is a master airfoil reference section axial width 306 of the master airfoil reference section 232. Nevertheless, any of the scaled airfoil sections may be the scaled airfoil reference section 258.

The scaled airfoil reference section axial width 304 is generally different than the master airfoil reference section axial width 306. That is, the scaled airfoil reference section axial width 304 is the dimension to which the master airfoil 200 is being axially scaled to tune the frequency of the scaled airfoil 202.

In step 114B, a ratio of the scaled airfoil reference section axial width 304 to the master airfoil reference section axial width 306 is calculated.

In step 114C, the scaled airfoil section axial width is calculated for each of the plurality of scaled airfoil sections. More specifically, each of the scaled airfoil sections includes a scaled airfoil section axial width ratio, which is the ratio of the corresponding scaled airfoil section axial width to the corresponding master airfoil section axial width. Each of the scaled airfoil section axial width ratios is the same as the ratio of the scaled airfoil reference section axial width 304 to the master airfoil reference section axial width 306. As such, the scaled airfoil section axial width for each of the scaled airfoil sections may be calculated by multiplying the scaled airfoil section axial width 304 and the corresponding master airfoil section axial width and dividing the product thereof by the master airfoil reference section axial width 306.

As mentioned above, the scaled airfoil 202 includes the first, second, third, fourth, and fifth scaled airfoil sections 236, 238, 240, 242, 244 in the embodiments shown in FIGS. 6 and 9. Each of these scaled airfoil sections 236, 238, 240, 242, 244 respectively include a first scaled airfoil section axial width ratio, a second scaled airfoil section axial width ratio, a third scaled airfoil section axial width ratio, a fourth scaled airfoil section axial width ratio, and a fifth scaled airfoil section axial width ratio. The first, second, third, fourth, and fifth scaled airfoil section axial width ratios are the same as the ratio of the scaled airfoil reference section axial width 304 to the master airfoil reference section axial width 306.

As mentioned above, multiple master airfoils 200 may form the row 224 of the master airfoil stage, and multiple scaled airfoils 202 may form the row 230 of the scaled airfoil stage. FIG. 10 illustrates a portion the master row 226 having three master airfoils 200. As shown, each of the master airfoils 200 is spaced apart by a master airfoil circumferential spacing 308. FIG. 11 shows a portion the scaled row 230 having two scaled airfoils 202. As shown, each of the scaled airfoils 202 is spaced apart by a scaled airfoil circumferential spacing 310.

In step 114D, a scaled airfoil circumferential spacing 310 is determined. More specifically, a ratio of the scaled airfoil circumferential spacing 310 to the scaled airfoil reference section axial width 304 is the same as a ratio of a master airfoil circumferential spacing 308 to the master airfoil reference section axial width 306. In this respect, the scaled airfoil circumferential spacing 310 may be calculated by multiplying the master airfoil circumferential spacing 308 by the scaled airfoil reference section axial width 304 and dividing the product thereof by the master airfoil reference section axial width 306.

In some embodiments, the scaled airfoil circumferential spacing 310 is different than the master airfoil circumferential spacing 308. In this respect, a number of scaled airfoils 202 in the scaled stage 230 may be different than a number of master airfoils 200 in the master stage. More specifically, the number of scaled airfoils 202 in the scaled stage 230 increases in step 114E if the scaled airfoil circumferential spacing 310 is less than the master airfoil circumferential spacing 308 for a given reference section diameter. In step 114F, however, the number of scaled airfoils 202 in the scaled stage 230 decreases if the scaled airfoil circumferential spacing 310 is greater than the master airfoil circumferential spacing 308 for a given reference section diameter. As shown in FIGS. 10 and 11, for example, the scaled airfoil circumferential spacing 310 is greater than the master airfoil circumferential spacing 308. As such, the scaled stage 230 has less scaled airfoils 202 than the master stage 226 has master airfoils 200. The number of scaled airfoils 202 in the scaled stage 230 may be tuned so as not to excite the natural frequencies of adjacent blade rows.

As mentioned above, steps 114G and 114H may be respectively used to tune the scaled airfoil 202 with the tip shroud 72 and part span shroud 76. More specifically, a position, a size, or a mass of the part span shroud 76 may be adjusted to modify or otherwise change the frequency response of the scaled airfoil 202 in step 114G. In step 114H, a position, a size, or a mass of the tip shroud 72 may be adjusted to modify or otherwise change the frequency response of the scaled airfoil 202.

As mentioned above, step 114 may tune the frequency response of the scaled airfoil 202 after radial scaling (i.e., steps 102-112). In particular, steps 114A-114F tune the frequency response of the scaled airfoil 202 by axially scaling the scaled airfoil 202. Step 114G tunes the frequency response of the scaled airfoil with the part span shroud 76. Step 114H tunes the frequency response of the scaled airfoil with the part span shroud 76. In this respect, steps 114G and 114H may be completed before steps 114A-114F. Furthermore, step 114H may be performed before step 114G.

The method 100 may include additional steps as well. For example, one or more of the scaled airfoils 202 may be manufactured using casting or any other suitable process.

Upon completion of the method 100, the master airfoil 200 is scaled radially and/or axially to form the scaled airfoil 202. In this respect, the scaled airfoil 202 has the same characteristics (e.g., work coefficient, reaction, velocity triangles, etc.) as the master airfoil 200. In some embodiments, the scaled airfoil 202 may rotate at the same speed as and at a different flow than as the master airfoil 200.

Unlike conventional scaling methods, the method 100 may independently radially and axially scale the master airfoil 200. In particular, the scaled airfoil reference section radius 256 may be determined independently of the scaled airfoil reference section axial width 304. That is, the scaled airfoil reference section radius 256 may be determined using one characteristic, and the scaled airfoil reference section axial width 304 using different characteristic. For example, the scaled airfoil reference section radius 256 may be determined using a stage count characteristic, while the scaled airfoil reference section axial width 304 using strength characteristic. Conventional scaling methods, however, cannot independently radially and axially scale airfoils. As such, the method 100 provides greater flexibility when scaling the master airfoil 200 than the conventional scaling methods.

Although generally described above in the context of steam turbine rotor blades, the method 100 may be used to scale any suitable turbomachine airfoil. For example, the methods 100 may be used to scale airfoils incorporated into gas turbine stator vanes and/or rotor blades as well.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for scaling an airfoil for placement in a turbomachine, the method comprising:
designing a master airfoil comprising a plurality of master airfoil sections, each master airfoil section comprising a master airfoil section radius and a master airfoil section axial width;
selecting one of the plurality of master airfoil sections as a master airfoil reference section, the master airfoil reference section comprising a master airfoil reference section radius and a master airfoil reference section axial width;
calculating for each of the plurality of master airfoil sections a ratio of the corresponding master airfoil section radius to the master airfoil reference section radius;
determining a scaled airfoil reference section radius for a scaled airfoil reference section of a scaled airfoil, the scaled airfoil reference section corresponding to the master airfoil reference section, the scaled airfoil comprising a plurality of scaled airfoil sections, each of the plurality of scaled airfoil sections corresponding to one of the plurality of master airfoil sections; and
calculating a scaled airfoil section radius for each of the plurality of scaled airfoil sections, wherein a ratio of the scaled airfoil section radius to the scaled airfoil reference section radius for each of the plurality of scaled airfoil sections is the same as the ratio of the master airfoil section radius to the master airfoil reference section radius for the corresponding master airfoil section.

2. The method of claim 1, further comprising:
cutting the scaled airfoil at a cut radius after calculating the scaled airfoil section radius for each of the plurality of scaled airfoil sections.

3. The method of claim 1, wherein selecting one of the plurality of master airfoil sections as the master airfoil reference section comprises selecting a master airfoil root as the master airfoil reference section.

4. The method of claim 1, further comprising:
tuning the scaled airfoil after calculating the scaled airfoil section radius for each of the plurality of scaled airfoil sections.

5. The method of claim 4, wherein tuning the scaled airfoil comprises adjusting a position, a size, or a mass of a part span shroud.

6. The method of claim 4, wherein tuning the scaled airfoil comprises adjusting a position, a size, or a mass of a tip shroud.

7. The method of claim 4, wherein tuning the scaled airfoil comprises:
determining a scaled airfoil reference section axial width of the scaled airfoil reference section;
calculating a ratio of the scaled airfoil reference section axial width to the master airfoil reference section axial width; and
calculating a scaled airfoil section axial width for the each of the plurality of scaled airfoil sections, wherein a ratio of the scaled airfoil section axial width to the corresponding master airfoil section axial width for each of the plurality of scaled airfoil sections is the same the ratio of the scaled airfoil reference section axial width to the master airfoil reference section axial width.

8. The method of claim 7, wherein tuning the scaled airfoil comprises at least one of adjusting a position, a size, or a mass of a part span shroud and adjusting a position, a size, or a mass of a tip shroud after calculating the scaled airfoil section axial width for the each of the plurality of scaled airfoil sections.

9. The method of claim 7, wherein determining the scaled airfoil reference section radius is independent of determining the scaled airfoil reference section axial width.

10. The method of claim 7, wherein tuning the scaled airfoil comprises determining a scaled airfoil circumferential spacing, wherein a ratio of the scaled airfoil circumferential spacing to the scaled airfoil reference section axial width is the same as a ratio of a master airfoil circumferential spacing to the master airfoil reference section axial width.

11. The method of claim 10, wherein tuning the scaled airfoil comprises:
increasing a number of airfoils in a stage of the turbomachine if the scaled airfoil circumferential spacing is less than the master airfoil circumferential spacing; and
decreasing the number of airfoils in the stage of the turbomachine if the scaled airfoil circumferential spacing is greater than the master airfoil circumferential spacing.

12. A method for scaling an airfoil for placement in a stage of a turbomachine, the method comprising:
designing a master airfoil comprising a plurality of master airfoil sections, each master airfoil section comprising a master airfoil section radius and a master airfoil section axial width;
selecting one of the plurality of master airfoil sections as a master airfoil reference section, the master airfoil reference section comprising a master airfoil reference section radius and a master airfoil reference section axial width;
calculating for each of the plurality of master airfoil sections a ratio of the corresponding master airfoil section radius to the master airfoil reference section radius;
determining a scaled airfoil reference section radius for a scaled airfoil reference section of a scaled airfoil, the scaled airfoil reference section corresponding to the master airfoil reference section, the scaled airfoil comprising a plurality of scaled airfoil sections, each of the plurality of scaled airfoil sections corresponding to one of the plurality of master airfoil sections;
calculating a scaled airfoil section radius for each of the plurality of scaled airfoil sections, wherein a ratio of the scaled airfoil section radius to the scaled airfoil reference section radius for each of the plurality of scaled airfoil sections is the same as the ratio of the master airfoil section radius to the master airfoil reference section radius for the corresponding master airfoil section; and
cutting the scaled airfoil at a cut radius.

13. The method of claim 12, further comprising:
tuning the scaled airfoil after cutting the scaled airfoil at the cut radius.

14. The method of claim 13, wherein tuning the scaled airfoil comprises adjusting a position, a size, or a mass of a part span shroud.

15. The method of claim 13, wherein tuning the scaled airfoil comprises adjusting a position, a size, or a mass of a tip shroud.

16. The method of claim 13, wherein tuning the scaled airfoil comprises:
determining a scaled airfoil reference section axial width of the scaled airfoil reference section;
calculating a ratio of the scaled airfoil reference section axial width to the master airfoil reference section axial width; and
calculating a scaled airfoil section axial width for the each of the plurality of scaled airfoil sections, wherein a ratio of the scaled airfoil section axial width to the corresponding master airfoil section axial width for each of the plurality of scaled airfoil sections is the same the ratio of the scaled airfoil reference section axial width to the master airfoil reference section axial width.

17. The method of claim 16, wherein determining the scaled airfoil reference section radius is independent of determining the scaled airfoil reference section axial width.

18. The method of claim 16, wherein tuning the scaled airfoil comprises determining a scaled airfoil circumferential spacing, wherein a ratio of the scaled airfoil circumferential spacing to the scaled airfoil reference section axial width is the same as a ratio of a master airfoil circumferential spacing to the master airfoil reference section axial width.

19. The method of claim 18, wherein tuning the scaled airfoil comprises:
increasing a number of airfoils in the stage if the scaled airfoil circumferential spacing is less than the master airfoil circumferential spacing; and
decreasing the number of airfoils in the stage if the scaled airfoil circumferential spacing is greater than the master airfoil circumferential spacing.

20. The method of claim 18, wherein tuning the scaled airfoil comprises at least one of adjusting a position, a size, or a mass of a part span shroud and adjusting a position, a size, or a mass of a tip shroud after determining the scaled airfoil circumferential spacing.
